(19) United States
(12) Patent Application Publication
(10) Pub. No.: US 2010/0119272 A1
(43) Pub. Date: May 13, 2010

(54) IMAGE FORMING APPARATUS CAPABLE OF INPUTTING A PAPER SIZE

(75) Inventor: Ui-choon LEE, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/507,840

(22) Filed: Jul. 23, 2009

(30) Foreign Application Priority Data
Nov. 10, 2008 (KR) 2008-111041

(51) Int. Cl. G03G 15/00

(52) U.S. Cl. 399/389

(57) ABSTRACT

An image forming apparatus, including a display part to input information about a print medium; a print medium tray to load the print medium; a paper guide to align the loaded print medium in the print medium tray; a sensor to sense information about the a of the print medium according to movement of the print medium guide; and a control unit to receive the sensed print medium size information from the sensor and to input the print medium size into the display part.

### CROSS-REFERENCE TO RELATED APPLICATION

This application claims the benefit of Korean Application No. 2008-111041, filed Nov. 10, 2008 in the Korean Intellectual Property Office, the disclosure of which is incorporated herein by reference.

### BACKGROUND OF THE INVENTION

1. Field of the Invention

Aspects of the present invention relate to image forming apparatuses, and more particularly, to an image forming apparatus capable of inputting a size of a print medium, sensed by a device to sense the print medium size, into a display part (e.g., a user interface window or a printer driver window) through a control unit, without a user directly inputting the print medium size into the display part.

2. Description of the Related Art

Generally, users of image forming apparatuses (such as an inkjet printer, a laser printer, and a photocopier) use a variety of print media having a variety of different sizes (hereinafter referred to as “user defined print medium”), in addition to standard-size print media, such as the A4 paper size. The user defined print media are generally used in image forming apparatuses that are supported by a paper tray such as a multipurpose tray.

Conventionally, in order to print printing data on a user defined print medium, the user directly inputs the size of the user defined print medium through a user interface window or a printer driver window. Accordingly, the user is inconvenienced. Furthermore, the user must know the print medium size. Thus, if the user is unable to measure the size of the user defined print medium, the user cannot input the print medium size.

### SUMMARY OF THE INVENTION

Aspects of the present invention provide an image forming apparatus to input the size of a print medium, sensed by a device capable of sensing the print medium size, into a display part (e.g., a user interface window or a printer driver window) through a control unit, without a user directly inputting the print medium size into the user interface window or the printer driver window.

According to an aspect of the present invention, there is provided an image forming apparatus, including: a display part to input information about a print medium; a print medium tray to load the print medium; a print medium guide to align the print medium loaded in the print medium tray; a sensor to sense information about the size of the print medium according to movement of the print medium guide; and a control unit to receive the sensed print medium size information from the sensor and to input the print medium size into the display part, and to determine the size of the print medium according to the print medium size information sensed by the sensor.

According to an aspect of the present invention, the display part may input information about a print medium designated by a user.

According to an aspect of the present invention, the print medium guide may be disposed in the print medium tray, and may include a first guide to align the print medium vertically and a second guide to align the print medium horizontally.

According to an aspect of the present invention, the sensor may sense information about a vertical size of the print medium and/or information about a horizontal size of the print medium according to the movement of the first guide and/or the second guide.

According to an aspect of the present invention, the display part may be a printer driver display window.

According to an aspect of the present invention, the sensor may sense information on the print medium size according to the movement of the print medium guide through a variable resistor and/or a variable capacitor.

According to an aspect of the present invention, a resistance value of the variable resistor and/or a capacitance of the variable capacitor may vary according to the movement of the print medium guide.

According to an aspect of the present invention, the print medium tray may be a manual tray, a print medium cassette, or a multipurpose tray.

According to an aspect of the present invention, the sensor may sense information about the vertical size of the print medium by loading the print medium vertically in the print medium tray and moving the print medium guide, and it may sense information about the horizontal size of the print medium by loading the print medium horizontally in the print medium tray and moving the print medium guide.

According to an aspect of the present invention, the control unit may receive the sensed vertical size information and the sensed horizontal size information of the print medium from the sensor and may input the print medium size into the display part.

According to another aspect of the present invention, there is provided a host apparatus connected to an image forming apparatus to determine a size of a print medium loaded into the image forming apparatus, the host apparatus including: a communication unit to receive a print medium size determined by the image forming apparatus and corresponding to a movement of a print medium guide of the image forming apparatus; a control unit to generate a user interface to display the received print medium size that corresponds to the movement of the print medium guide; and a display unit to display the generated user interface.

According to yet another aspect of the present invention, there is provided a system to determine a size of a print medium, the system including: an image forming apparatus, including: a print medium tray to load the print medium, a print medium guide to align the print medium loaded in the print medium tray, a sensor to sense information about the size of the loaded print medium according to movement of the print medium guide, and a control unit to perform a printing operation on the print medium based on the print medium size that is determined according to the print medium size information sensed by the sensor; and a host apparatus to display the print medium size.

According to still another aspect of the present invention, there is provided a method of determining a size of a print medium loaded in an information storage medium, the method including: sensing, by a sensor of the image forming apparatus, information about a size of the loaded print medium according to a movement of a print medium guide on the image forming apparatus; determining, by a processor, the print medium size according to the sensed print medium size information; and performing a printing operation on the print medium based on the determined print medium size.

According to another aspect of the present invention, there is provided a host apparatus connected to an image forming apparatus to determine a size of a print medium loaded into the image forming apparatus, the host apparatus including: a communication unit to receive print medium size information sensed by the image forming apparatus and corresponding to a movement of a print medium guide of the image forming apparatus; and a control unit to determine the print medium size according to the received print medium size information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a printer driver window that is activated on a user interface display when a user executes a command to print according to an embodiment of the present invention;

FIG. 2 illustrates a display through which a layout, a print medium, a graphic, and additional information are displayed where any property key of the printer driver window shown in FIG. 1 is executed can be changed according to an embodiment of the present invention;

FIG. 3 illustrates a display for a user defined print medium displayed where a paper designating key is executed on the display shown in FIG. 2 according to an embodiment of the present invention;

FIG. 4 is a top plan view of a print medium tray in which the print medium is received and a print medium guide to guide the print medium according to an embodiment of the present invention;

FIG. 5 is a perspective view of the print medium tray and the print medium guide according to an embodiment of the present invention;

FIG. 6 illustrates a print medium size sensor to sense a print medium size, a connection of the print medium size sensor, and a control unit of the image forming apparatus according to an embodiment of the present invention; and

FIG. 7 is an exploded view of the print medium size sensor shown in FIG. 7.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The image forming apparatus according aspects of the present invention may include a printer, a multipurpose machine or the like that performs a printing operation to form images on a print medium (e.g., paper, transparencies, etc.) based on printing data. The image forming apparatus receives the printing data from a host (such as a personal computer (PC), a sender's facsimile machine, a camera, etc.), reads the printing data stored in a storage such as a universal serial bus (USB) memory, or produces the printing data through a scanning by a scanning device internally installed therein. Image forming by the image forming apparatus may be performed by an inkjet printing or a laser printing, but is not limited thereto.

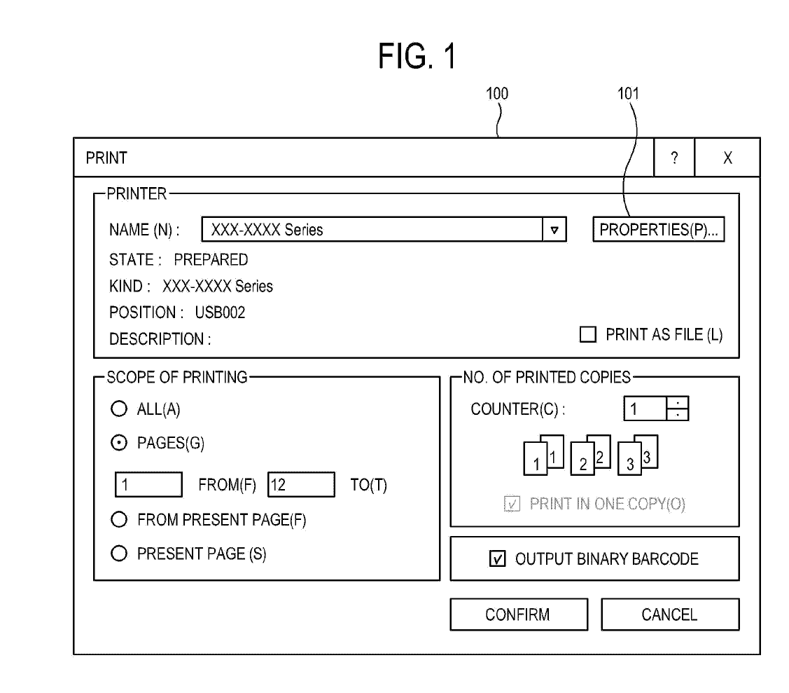

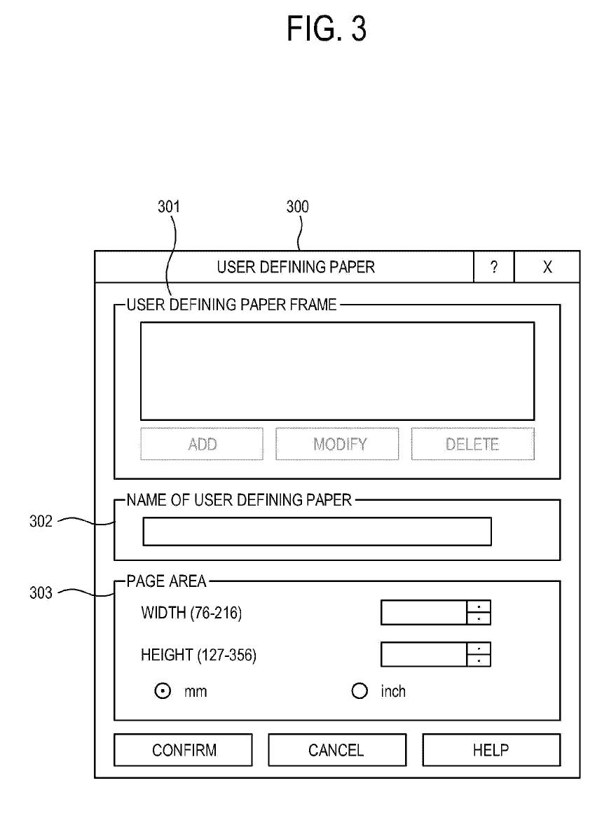

FIGS. 1 to 4 are provided to explain an image forming apparatus according to an embodiment of the present invention, illustrating a display part into which a kind, a name, and/or a size of a user defined print medium is input though a printer driver window 100, 200 or 300. The display part for the image forming apparatus 1 may be displayed on a host (such as a PC, a mobile phone, a portable digital assistant, etc.) or a display device installed in the image forming apparatus 1 (such as a display panel). Where the display part is displayed on the host, the image forming apparatus 1 transmits data on the print medium size to the host, and the host displays the display part based on the transmitted print medium size data. Hereinbelow, with respect to the display part according to an embodiment of the present invention, a printer driver window 100, 200, 300 will be explained by way of example. It is understood that aspects of the present invention are not limited to a printer driver window 100, 200, 300, and can be applied to any user interface corresponding to an image forming apparatus 1. Furthermore, aspects of the present invention are also applicable to a case where the display part is displayed on the display device of the image forming apparatus 1.

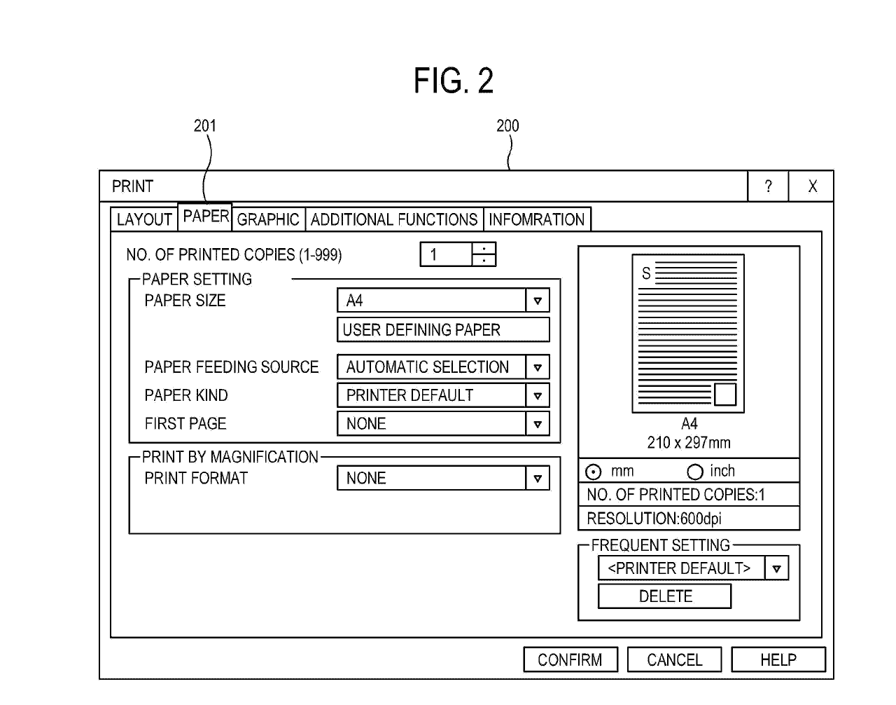

Referring to FIG. 1, a printer driver window 100 is displayed as a user interface when a user executes a command to print, and the user can change any property of the image forming apparatus 1 through the printer driver window 100. If the user selects and executes a property key 101 to change a property of the image forming apparatus 1, a printer driver window 200 for the selected property key 101 is activated as shown in FIG. 2. It is possible to change a layout, a print medium, a graphic, and/or additional information through the printer driver window 200. If a key 201 involved in designation of a print medium is selected and executed, a printer driver window 300 with respect to a user defined print medium (hereinafter referred to as “user defined print medium display”) is activated, so that the user can directly input a kind, a name, and/or a size of a print medium different in size from the standard A4 paper, to form images on the print medium.

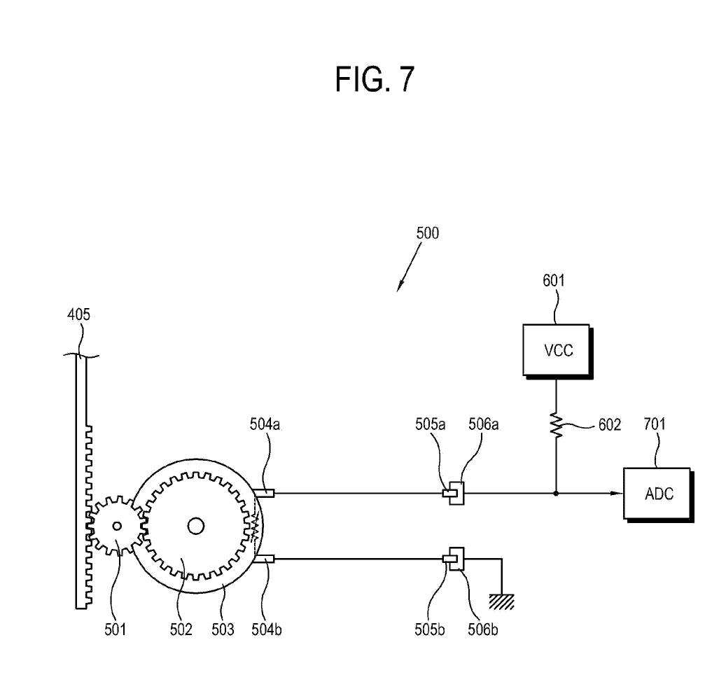

To describe the user defined print medium display 300 in more detail, the user defined print medium display is configured with a user defined print medium frame 301, a user defined print medium name input unit 303, and a page space 303. Accordingly, the user can input the size of the user defined print medium in the page space 303, and the name of the user defined print medium in the user defined print medium name input unit 302, so as to distinguish a user defined print medium having a specific size. The user defined print medium frame 301 displays to the user at least one user defined print medium name input through the user defined print medium name input unit 302. For example, the user measures the size of the user defined print medium in vertical and horizontal directions and inputs the measured user defined print medium size into the user defined print medium display 300, though it is understood that aspects of the present invention are not limited thereto. According to other aspects, the user defined print medium size is input through a print medium size sensor 500 (FIG. 7), to be described later.

FIGS. 1 to 3 illustrate by way of example that the size of the user defined print medium is input through the printer driver windows 100, 200 and 300, though embodiments of the present invention are not limited thereto. For example, where a user inserts the user defined print medium in the print medium tray, such as a multipurpose tray 400, and aligns the print medium guide adaptively to the user defined print medium by moving the print medium guide 401, an active window (such as a popup window) is launched on the user defined print medium display. In detail, the active window displays information about the print medium size resulting from a movement of the print medium guide 401 as input into the active window, thereby allowing the user to visually perceive information about the user defined print medium. The active window may also be linked to the printer driver windows 100, 200 and 300 shown in FIGS. 1 to 3, thereby allowing the print medium size information input into the active window to be automatically input into the user defined print medium display 300 thereof.

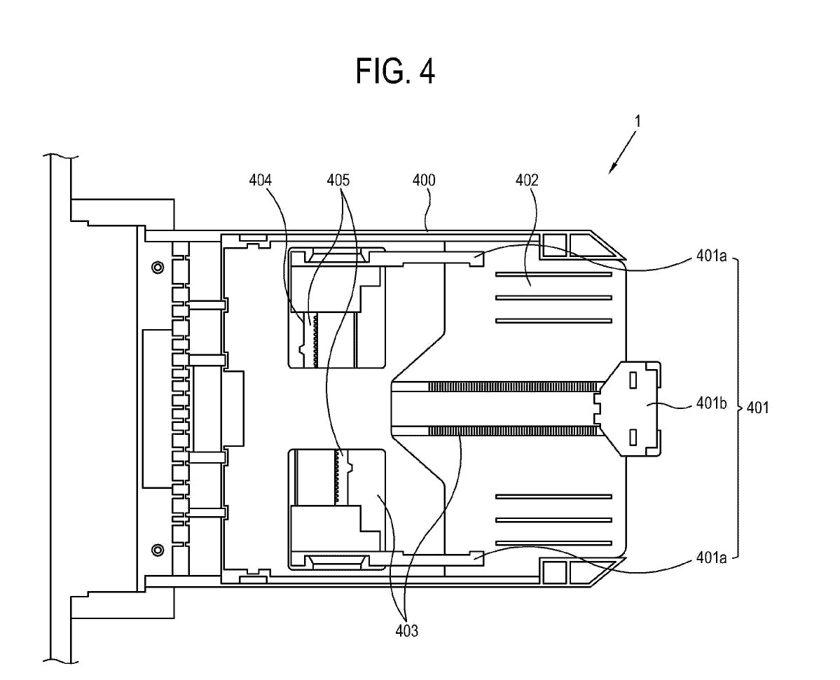

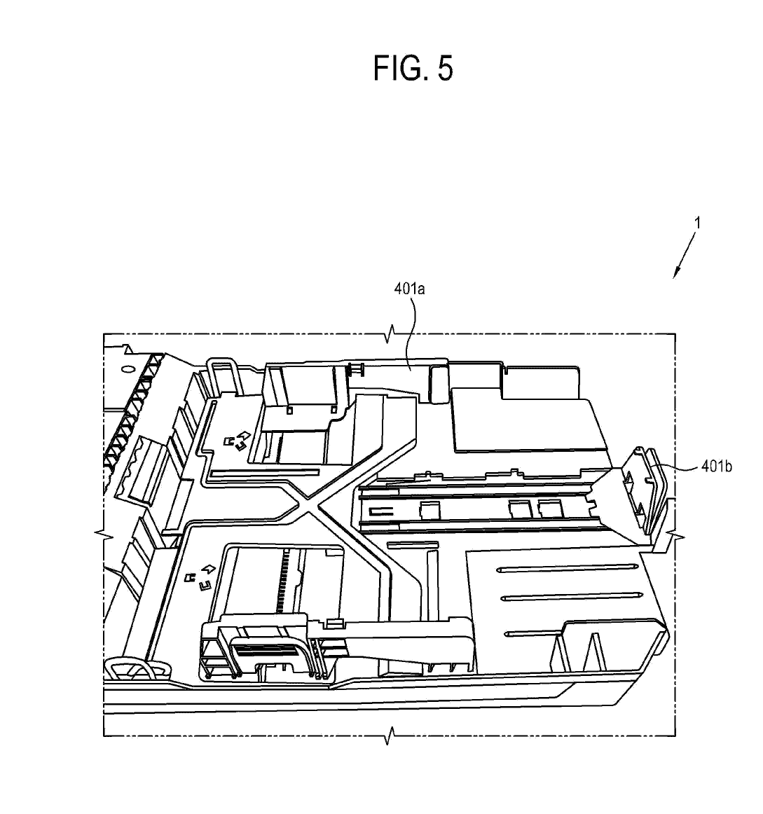

FIGS. 4 and 5 are respectively a top plan view and a perspective view of the print medium tray 400 in which print media are received, and the print medium guide 401 guiding the print media. Referring to FIGS. 4 and 5, the image forming apparatus 1 according to an embodiment of the present invention includes the print medium tray 400 and the print medium guide 401. In addition, the image forming apparatus 1 further includes a print medium loading plate 402, a guide rail 403, a guide groove 404, and a rack gear 405. While not shown, it is understood that the apparatus 1 further includes a controller to control an operation of the apparatus, and a printing unit which prints data on a print medium.

Referring to FIG. 4, the user loads the user defined print medium in the print medium tray 400, moves the print medium guide 401 disposed within the paper tray 400, and aligns the user defined print medium thereto. In detail, the print medium guide 401 moves on the print medium loading plate 402 supporting the print medium in order to guide the print medium. The print medium guide 401 includes a first guide 401a to guide the print medium vertically (i.e., lengthwise relative to the medium) and a second guide 401b to guide the print medium horizontally (i.e., widthwise relative to the medium). Thus, the print medium guide 401 can move adaptively to the vertical and the horizontal corners of the print medium. With respect to the print medium guide 401, aspects of the present invention are not limited to the number, the disposition direction, and the movement direction of the print medium guide 401 illustrated in FIG. 4. In addition, though FIG. 4 depicts that the print medium guide 401 includes both the first guide 401a and the second guide 401b, it is understood that aspects of the present invention are not limited thereto. According to other aspects, the print medium guide 401 may be configured with either the first guide 401a or the second guide 401b, or a plurality of first guides 401a and/or second guides 401b.

The first guide 401a and the second guide 401b are movable along the guide rail 403 and/or the guide groove 404, and the rack gear 405 is connected to the first guide 401a and the second guide 401b. The rack gear 405 is linked to a print medium size sensor 500 (FIG. 7) such as a variable resistor, to be described later.

The print medium tray 400 may be, for example, a cassette tray, a manual feeding tray, and/or a multipurpose tray. The multipurpose tray receives and guides various kinds of print media having various sizes as well as the standard 8.5×11 or A4 paper, for multiple purposes, and feeds the print media. That is, the print medium tray 400 receives and guides print media of any size within a maximum size and a minimum size that can be received by the print medium tray 400. FIG. 4 illustrates the print medium tray 400 as a multipurpose tray by way of example, though it is understood that aspects of the present invention are applicable to any kind of print medium tray.

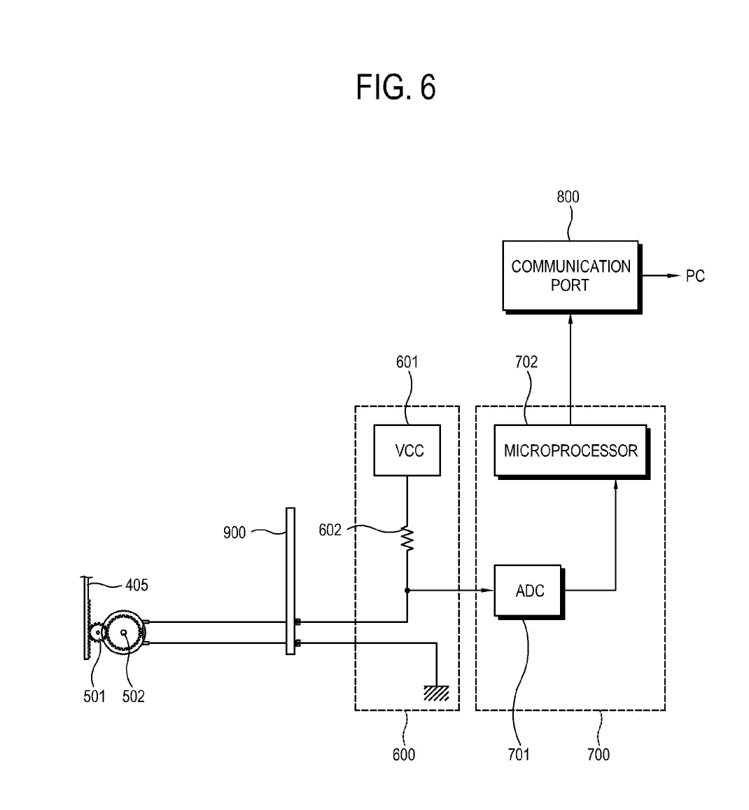

FIG. 6 shows the print medium size sensor to sense the print medium size, a connection unit of the print medium size sensor, and a control unit of the image forming apparatus, and FIG. 7 depicts the print medium size sensor 500 in detail. That is, the image forming apparatus 1 according an embodiment of the present invention further includes the print medium size sensor 500 to sense the print medium size according to a movement of the paper guide 401, and a control unit 700 to input the print medium size into the display part based on the sensed print medium size. The print medium size sensor 500 is an example of a sensor according to aspects of the present invention.

As described above, the paper tray 400 according an embodiment of the present invention is equipped with the print medium size sensor 500 that automatically determines the print medium size. The print medium size sensor 500 may include, but is not limited to, a variable resistor, a variable capacitor, and/or an actuator sensor.

Referring to FIGS. 6 and 7, the variable resistor is illustrated as an example of the print medium size sensor 500. The print medium size sensor according an embodiment of the present invention includes a pinion gear 501, a rotary gear 502, and a resistance body 503. If the user moves the print medium guide 401 to align the print medium, the rack gear 405 linked to the print medium guide 401 is also moved. As the rack gear 405 moves, the pinion gear 501 connected to the rack gear 405 is rotated, and the rotary gear 502 connected to the pinion gear 501 is rotated. The resistance body 503 coupled with the rotary gear 502 has two terminals 504a and 504b contacting an outer circumferential surface of the resistance body 503. The resistance body 503 may be configured integrally with the rotary gear 502.

Furthermore, the resistance body 503 may include resistance material layers different in thickness, in an inner circumferential direction from the outer circumferential surface (for example, along the circumferential direction), so as to make the resistance values between the two terminals 504a and 504b vary depending on the rotation positions thereof. Accordingly, the variable resistor sensor 500 provides different resistance values through both ends of the two terminals 504a and 504b according to the rotation position of the pinion gear 501.

The image forming apparatus 1 further includes a voltage signal generating source 600 having a direct current voltage source 601 and a fixed resistance element 602. In addition, the image forming apparatus 1 further includes an analog-digital converter (ADC) 701 installed within the control unit 700. The voltage signal generating source 600 generates voltage signals corresponding to the resistance values of the two terminals 504a and 504b. Moreover, the voltage signal generating source 600 is connected to the fixed resistance element 602 so as to divide the voltage level of the direct current voltage source 601 provided therein from the resistance values of the two terminals 504 and 504b, and the voltage signal whose voltage is reduced by the resistance values between the two terminals 504a and 504b of the variable resistor 500 is output to the analog-digital converter 701.

The image forming apparatus 1 further includes a frame 900, and the print medium size sensor 500 further includes projected terminals 505a and 505b and coupling terminals 506a and 506b. To connect the print medium tray 400 to the frame 900 electrically, when the print medium tray 400 is installed in the frame 900, the two terminals 504a and 504b are connected to the terminals 505a and 505b projected at ends of the frame 900, and the print medium tray 400 capable of being drawn into and out of the frame 900 is mounted inside. In this state, the terminals 505a and 505b contact coupling terminals 506a and 506b that are engaged with each other as male and female terminals.

In the case where the print medium size sensor is the variable capacitor, an operation thereof is similar to that of the variable resistor sensor 500 described above. Thus, a description of the variable capacitor will be omitted herein. In the case where the print medium size sensor is an actuator sensor, the actuator sensor checks on/off operations. Thus, by using n number of actuator sensors, 2n types of print media can be distinguished. Furthermore, the actuator sensor can be used individually, or jointly with the variable resistor sensor 500. For example, the variable resistor sensor 500 may be used to obtain information about the width of a print medium, and the actuator sensor may be used to obtain information about the length of the print medium.

The control unit 700 includes an analog-digital converter 701 to convert an input voltage signal into a digital signal, and a microprocessor 702 to read the digital signal to determine the print medium size. The image forming apparatus 1 may further include a communication port 800 to perform communications with the host (such as a PC).

The microprocessor 702 is configured to determine the print medium size by reading the input digital signal, to receive printing data input and output through the communication port 800, and to control general printing operations. The determined print medium size data is provided to the display device (not shown) and/or the host (PC) connected through the communication port 800.

The configuration to input the size of the user defined print medium into the user defined print medium display 300 so that the user can perceive the size will now be described. A resistance value and/or a capacitance of the variable resistor and/or the variable capacitor sensor 500 at the moved position of the print medium guide 401 is determined. The determined resistance value and/or capacitance is converted into a digital signal through the analog-digital converter 701 and transmitted to the control unit 700 of the image forming apparatus 1. To input the size information of the user defined print medium into the user defined print medium display 300, the control unit 700 retrieves the print medium size information corresponding to the received digital signal through a lookup table stored in the control unit 700 or in a memory of the image forming apparatus 1, and inputs the size into the user defined print medium display 300. However, the inputting of the print medium size information through the lookup table is merely by way of example, and aspects of the present invention are not limited thereto. For example, according to another aspect of the present invention, the size may be determined from the received digital signal according to an algorithm.

Moreover, though the above-described embodiments provide the image forming apparatus to determine the print medium size, it is understood that all aspects are not limited thereto. For example, the image forming apparatus may transmit a digital signal and/or print medium size information sensed by the sensor to a host apparatus, whereby the host apparatus determines the print medium size therefrom.

While not restricted thereto, aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus, comprising:
a print medium tray to load a print medium;
a print medium guide to align the print medium loaded in the print medium tray;
a sensor to sense information about a size of the loaded print medium according to movement of the print medium guide; and
a control unit to determine a size of the print medium according to the print medium size information sensed by the sensor, and to perform a printing operation on the print medium based on the determined print medium size.

2. The image forming apparatus as claimed in claim 1, wherein the control unit displays a user interface to input information about the loaded print medium.

3. The image forming apparatus as claimed in claim 1, wherein the print medium guide is disposed in the print medium tray, and comprises a first guide to align the print medium lengthwise and a second guide to align the print medium widthwise.

4. The image forming apparatus as claimed in claim 3, wherein the sensor senses information about a lengthwise size of the print medium and information about a widthwise size of the print medium according to movement of the first guide and/or the second guide.

5. The image forming apparatus as claimed in claim 2, wherein the user interface is a printer driver display window.

6. The image forming apparatus as claimed in claim 1, wherein the sensor comprises a variable resistor and/or a variable capacitor to sense the print medium size information according to the movement of the print medium guide.

7. The image forming apparatus as claimed in claim 6, wherein a resistance value of the variable resistor and/or a capacitance of the variable capacitor vary according to the movement of the print medium guide, and the control unit determines the print medium size according to the resistance value and/or the capacitance.

8. The image forming apparatus as claimed in claim 7, further comprising a rack gear connected to the print medium guide and the sensor and moving according to the movement of the print medium guide,
wherein the sensor further comprises:
a pinion gear connected to the rack gear, and rotating according to a movement of the rack gear;
a rotary gear connected to the pinion gear, and rotating according to a rotation of the pinion gear; and
a resistance body coupled with the rotary gear and comprising at least one terminal contacting an outer circumferential surface of the resistance body, the at least one terminal providing the resistance value corresponding to a rotation position of the pinion gear.

9. The image forming apparatus as claimed in claim 8, further comprising a voltage signal generating source to generate a voltage signal corresponding to the resistance value provided through the at least one terminal,
wherein the control unit converts the voltage signal to a digital signal, and determines the print medium size according to the digital signal.

10. The image forming apparatus as claimed in claim 6, further comprising a voltage signal generating source to generate a voltage signal corresponding to the resistance value and/or the capacitance,
wherein the control unit converts the voltage signal to a digital signal, and determines the print medium size according to the digital signal.

11. The image forming apparatus as claimed in claim 1, wherein the print medium tray is a manual tray, a print medium cassette, or a multipurpose tray.

12. The image forming apparatus as claimed in claim 1, wherein:
the sensor senses information about a lengthwise size of the loaded print medium according to a movement of the print medium guide to align the loaded print medium lengthwise; and
the sensor senses information about a widthwise size of the loaded print medium according to a movement of the print medium guide to align the loaded print medium widthwise.

13. The image forming apparatus as claimed in claim 4, wherein the control unit determines the print medium size based on the sensed lengthwise size information and the sensed widthwise size information of the print medium.

14. The image forming apparatus as claimed in claim 12, wherein the control unit determines the print medium size based on the sensed lengthwise size information and the sensed widthwise size information of the print medium.

15. The image forming apparatus as claimed in claim 1, further comprising a frame comprising one or more coupling terminals,
wherein the print medium tray comprises one or more tray coupling terminals to connect to the one or more coupling terminals in order to electrically connect the sensor to the control unit.

16. The image forming apparatus as claimed in claim 1, further comprising a display unit to display the determined print medium size.

17. The image forming apparatus as claimed in claim 1, further comprising a communication unit to transmit the determined print medium size to a host apparatus.

18. The image forming apparatus as claimed in claim 10, further comprising a memory to store a lookup table,
wherein the control unit retrieves the print medium size corresponding to the digital signal from the lookup table.

19. A host apparatus connected to an image forming apparatus to determine a size of a print medium loaded into the image forming apparatus, the host apparatus comprising:
a communication unit to receive a print medium size determined by the image forming apparatus and corresponding to a movement of a print medium guide of the image forming apparatus;
a control unit to generate a user interface to display the received print medium size that corresponds to the movement of the print medium guide; and
a display unit to display the generated user interface.

20. The host apparatus as claimed in claim 19, wherein the user interface adaptively displays the print medium size according to movements of the print medium guide.

21. A system to determine a size of a print medium using the image forming apparatus of claim 1, the system further comprising:
a host apparatus connected to the image forming apparatus to display the determined print medium size.

22. The system as claimed in claim 21, wherein the host apparatus comprises:
a communication unit to receive the print medium size from the image forming apparatus;
a control unit to generate a user interface to display the received print medium size; and
a display unit to display the generated user interface.

23. The system as claimed in claim 21, wherein the host apparatus comprises:
a communication unit to receive the print medium size information; and
a control unit to determine the print medium size according to the received print medium size information.

24. A method of determining a size of a print medium loaded in an information storage medium, the method comprising:
sensing, by a sensor of the image forming apparatus, information about a size of the loaded print medium according to a movement of a print medium guide on the image forming apparatus;
determining, by a processor, the print medium size according to the sensed print medium size information; and
performing a printing operation on the print medium based on the determined print medium size.

25. The method as claimed in claim 24, further comprising displaying the determined print medium size on a display.

26. A host apparatus connected to an image forming apparatus to determine a size of a print medium loaded into the image forming apparatus, the host apparatus comprising:
a communication unit to receive print medium size information sensed by the image forming apparatus and corresponding to a movement of a print medium guide of the image forming apparatus; and
a control unit to determine the print medium size according to the received print medium size information.

27. The host apparatus as claimed in claim 26, further comprising a memory to store a lookup table,
wherein the control unit retrieves the print medium size corresponding to the received print medium size information from the lookup table.
